(19) United States
(12) Patent Application Publication
(10) Pub. No.: US 2026/0192301 A1
(43) Pub. Date: Jul. 9, 2026

(54) WELL ELEMENT, SAMPLE SLIDE ASSEMBLY, TREATMENT APPARATUS, AND A METHOD OF TREATING A SAMPLE SLIDE ASSEMBLY

(71) Applicant: Resolve BioSciences GmbH, Monheim am Rhein (DE)

(72) Inventor: Cheng Frank ZHONG, Düsseldorf (DE)

(21) Appl. No.: 19/131,597

(22) PCT Filed: Oct. 31, 2023
(86) PCT No.: PCT/EP2023/080300

§ 371 Date: May 21, 2025

Related U.S. Application Data
(60) Provisional application No. 63/428,522, filed on Nov. 29, 2022.

(51) Int. Cl. B01L 3/00

(52) U.S. Cl. CPC B01L 3/5085; B01L 2200/0642; B01L 2300/0822; B01L 2300/0829; B01L 2300/0851; B01L 2300/0858

(57) ABSTRACT

Page 3 The present invention refers to a well element for a sample slide assembly. The well element comprises a depressed and/or concave recess portion which is formed in or on an upper surface of a body, and a rim portion surrounding said recess portion in a plan view and/or in a cross-sectional view onto said upper surface of said body. Said rim portion has an apex or a cusp which—in said plan view—is pointing towards at least one of a side or a side edge and an assigned tilting axis (X, Y) of the well and/or its body.

The present invention refers to a well element, a sample slide assembly, a treatment apparatus, and a method of treating a sample slide assembly.

In particular, the present invention relates to a well element for a sample slide assembly and to a treatment apparatus for treating a sample slide assembly.

Nowadays, when handling one or plural samples of one or plural specimens or the like, so called multiwell plates are commonly used. In general, a well defines a spatial portion in the sense of an open or closed vessel formed in or on a solid body which is designed for receiving a sample and for spatially separating the received sample from other portions of the underlying solid body and in particular from other vessels, wells and/or samples.

For instance, prior art document DE 20 2005 007 547 U1 discloses a conventional multiwell plate which—in this case—is suitable for the electrophysiological investigation of specimens, namely by having provided an electrode configuration on or in the bottom portions of the underlying wells.

In general, such a multiwell plate comprises plural wells which are formed in or on an upper surface of an underlying substrate plate, wherein each of said wells has a quadratic shape or a rectangular shape when seen in a plan view or cross-sectional view onto said upper surface. In addition, the side edges of the shapes of the underlying wells are oriented in parallel with respect to the side edges of the body on the upper surface of which the wells are formed as well as parallel to the tilting axes of an external tilting mechanism.

The usage of such conventional multiwell plates and their arrangement in a common treatment apparatus have a variety of drawbacks. For instance, when attempting complete aspiration of the wells'volume. Two tilting operations with non-parallel tilting axes (in general perpendicular tilting axes are involved) are required in order to obtain a tilted orientation of the wells such that any fluid residue remaining in the well is collected in an edge region defined by the well's rim and can easily be removed, e.g. by pipette action.

However, the common usage of tilting operations requires two independently controllable tilting mechanisms, thereby yielding an excess of equipment and manipulation efforts and also giving rise the lack a reliability and increase of operational errors.

It is an object underlying the present invention to yield a well element, a sample slide assembly, a treatment apparatus, and a method of treating a sample slide assembly, which offer a simplified handling at reduced costs and at less error impact.

The object underlying the present invention is achieved by a well element according to independent claim 1, by a sample slide assembly according to independent claim 8, a treatment apparatus according to independent claim 11, and a method of treating a sample slide assembly according to independent claim 12. Preferred embodiments of the present invention are defined in the respective dependent claims.

According to a first aspect of the present invention, a well element for a sample slide assembly is proposed. The well element comprises recess portion which may be referred to as a depressed and/or concave portion or recess portion. The recess portion is formed in or on an upper surface of an underlying body. A rim portion of the well element surrounds said recess portion in a plan view and/or in a cross-sectional view onto said upper surface of said body. Said rim portion has an apex or a cusp which—in said plan view—is pointing towards at least one (i) of a side or a side edge of the well and/or its body and (ii) of a tilting axis which is assigned to the well and/or its body. According to the present invention's measures, a simplified handling at reduced costs and at less error impact is achieved.

According to a preferred embodiment of the present invention's well element, the rim portion or a part thereof—in said plan view-may have a shape of a polyline or of a polygonal chain. This allows a comparable simplified manufacturing process and a high degree of definiteness of the well's apex and elaborate collecting properties for any fluid residue.

Alternatively or additionally, the rim portion or a part thereof—in said plan view-may have a shape of a curved line or of a concatenation of curved lines.

Linear and curved rim designs may be combined.

According to a further alternative or additional embodiment of the present invention, the rim portion or a part thereof—in said plan view-may be or may form a side of the well that is not parallel to a side edge and/or to an assigned tilting axis of the well and/or its body.

The rim portion or a part thereof—in said plan view-may also be or may form two sides of the underlying well which are joint in connection in or at an angle that is—in particular-different from 0° and from 180°, with the connection and the angle forming the apex as a point or as a region which is-among all other points of the joint two sides (i) in their entirety or (ii) in a neighborhood of said apex-located closest or nearest to a side edge and/or an assigned tilting axis of the well and/or its body.

The body of the well may be a slide body or a body of a sample slide, each of a superordinate sample slide assembly, or a respective part thereof.

Additionally or alternatively, the body of the well may be a planar or essentially planar member and/or a platelike or essentially platelike member.

It may have a planar or an essentially planar upper surface and a lower surface which is opposed to the upper surface.

With such a well element according to the present invention, a comparable large variety of applications is enabled.

For instance, the apex or cusp of the rim portion and their geometric features may be configured in order to be suitable for being used as fiducial targets in order to determine and/or to register a location and/or an orientation of the well element, of the body, and/or of the superordinate sample slide assembly.

The present invention further relates to sample slide assembly as such, which comprises a slide body having an upper surface.

Under such circumstances, in or on said upper surface at least one well element according to the present invention is formed.

In a plan view onto said upper surface of said slide body, said upper surface is surrounded by side edges, and the well element is oriented in or on the surface such that the apex or cusp of the well element is pointing towards one of said side edges.

The sample slide assembly's slide body may be planar or essentially planar and/or it may be platelike or essentially platelike.

Furthermore, the sample slide assembly's slide body may additionally or alternatively have a planar or an essentially planar upper surface and/or a lower surface opposed to said upper surface.

The present invention's sample slide assembly may comprise plural well elements, wherein said plural well elements are—in particular—identical in form, shape, dimension and/or orientation.

Also a treatment apparatus, namely for treating a sample slide assembly, is suggested according to the present invention. The apparatus comprises a holding means for releasably holding a sample slide assembly, as well as a tilting means for conditionally and/or controllably tilting a sample slide assembly about a tilting axis, when the sample slide assembly is held by said holding means.

The holding means and/or said tilting means are configured such that, when holding a sample slide assembly which is formed according to the present invention, an apex or a cusp of a rim portion of a well of the sample slide assembly—in said plan view onto a slide body—is pointing towards the tilting axis.

Eventually, a method of treating a sample slide assembly is proposed in terms of the present invention, the method comprising a holding step of releasably holding a sample slide assembly, and a tilting step of controllably and/or conditionally tilting a sample slide assembly about a tilting axis, when a sample slide assembly is held during said holding step.

According to the present invention, said holding step and/or said tilting step are configured such that, when holding a sample slide assembly, which is formed according to the present invention, an apex or a cusp of a rim portion of a well of the sample slide assembly—in a plan view onto an underlying slide body—is pointing towards the tilting axis.

These and further details, advantages and features of the present invention will be described based on embodiments of the invention and by taking reference to the accompanying figures.

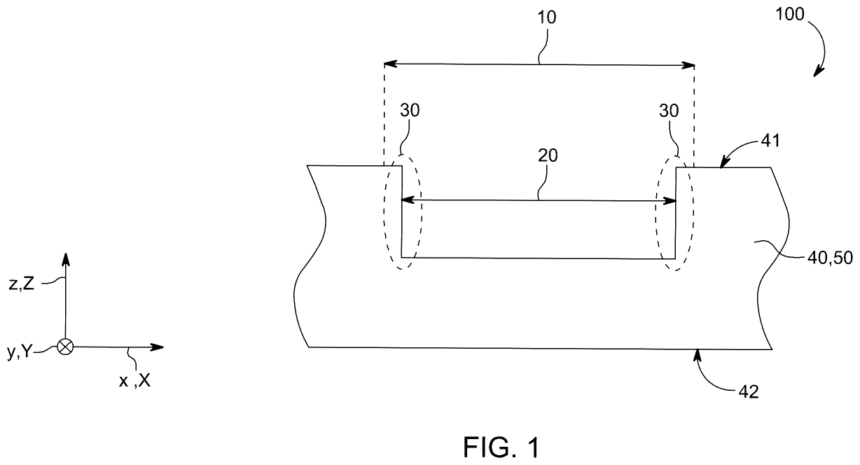

FIG. 1 is a schematic cross sectional side view of a first embodiment of the present invention's sample slide assembly comprising at least one well element according to one embodiment of the present invention.

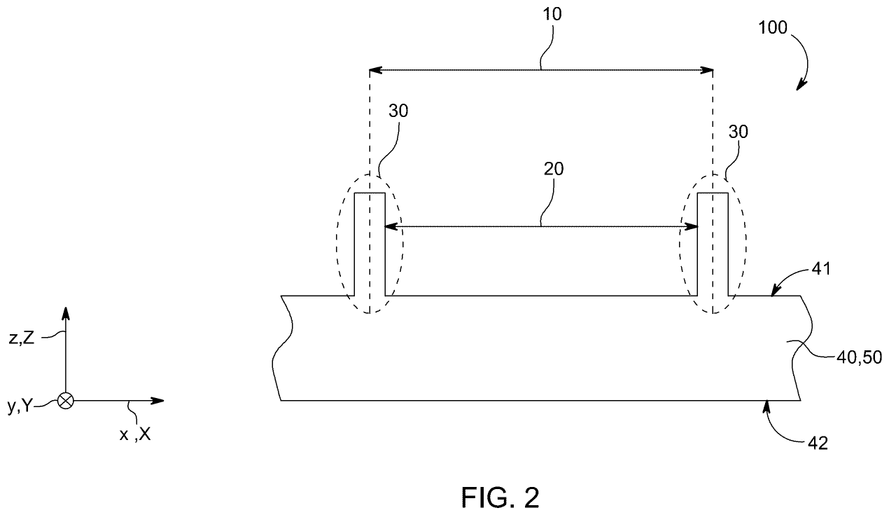

FIG. 2 is a schematic cross sectional side view of a second and alternative embodiment of the present invention's sample slide assembly comprising at least one well element according to another embodiment of the present invention.

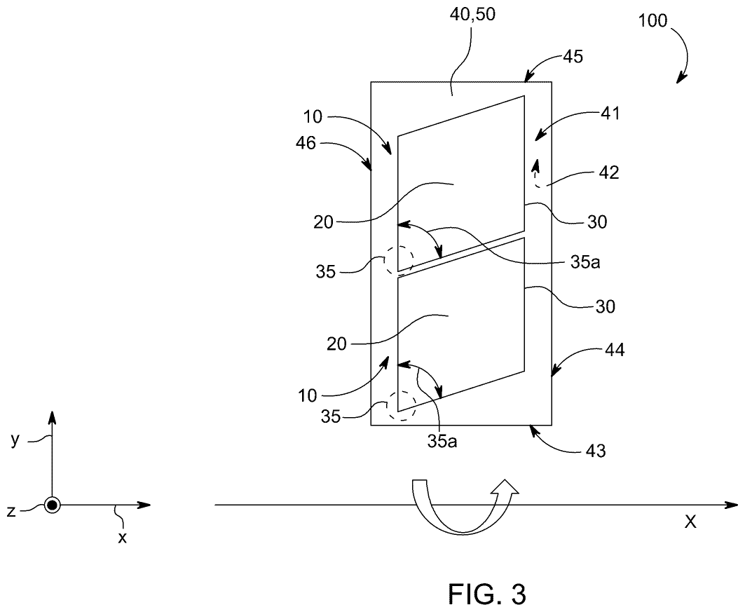

FIG. 3 is a schematic plan view onto an upper surface of an embodiment of the present invention's sample slide assembly comprising plural well elements, the well elements having an identical shape of a first kind in said plan view.

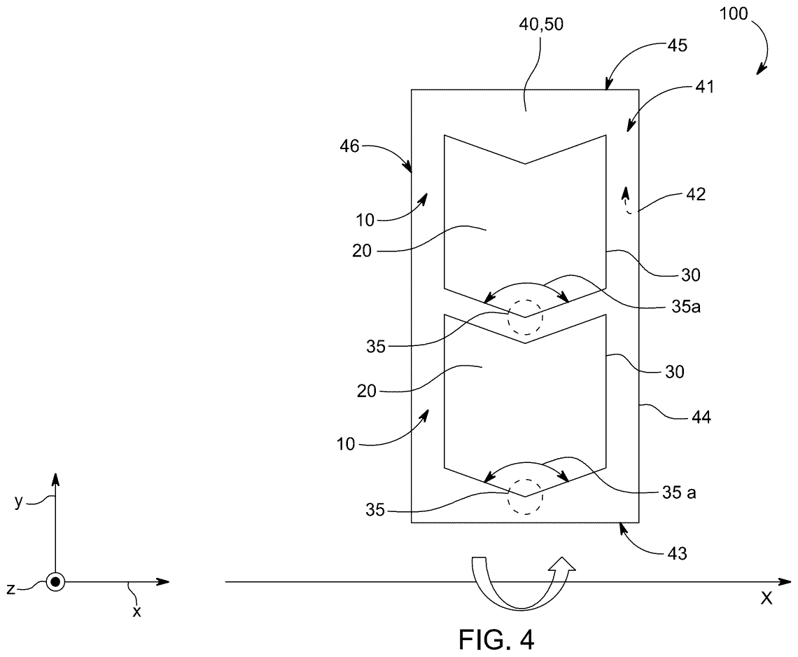

FIG. 4 is a schematic plan view onto an upper surface of another embodiment of the present invention's sample slide assembly comprising plural well elements, the well elements having an identical shape of a second kind in said plan view.

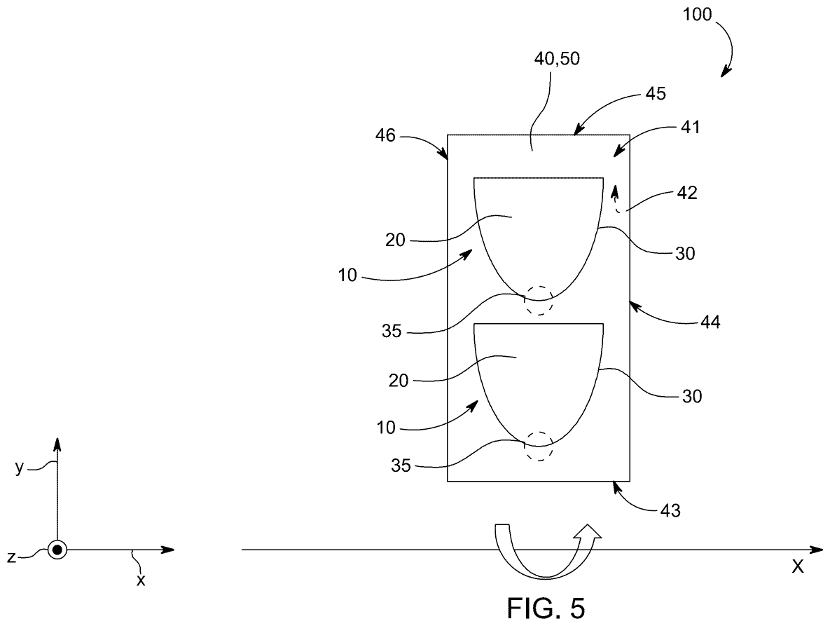

FIG. 5 is a schematic plan view onto an upper surface of still another embodiment of the present invention's sample slide assembly comprising plural well elements, the well elements having an identical shape of a third kind in said plan view.

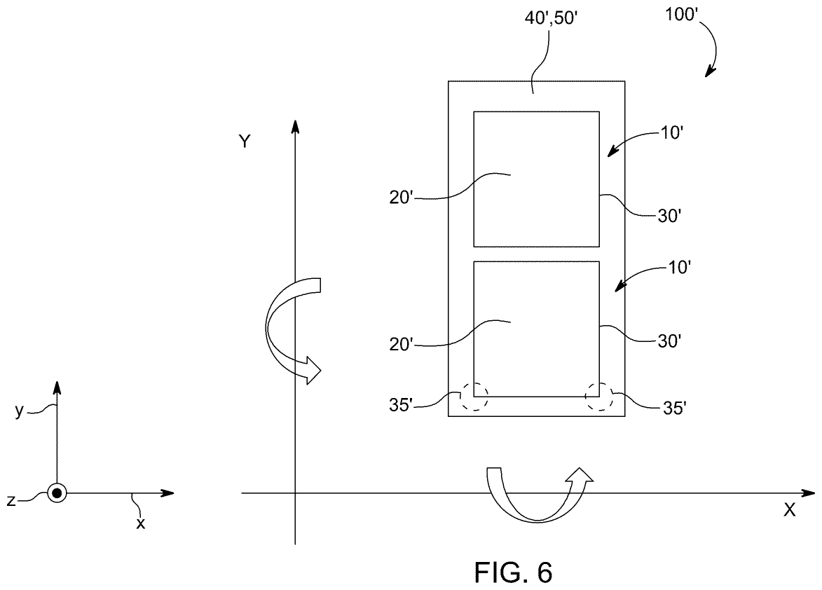

FIG. 6 is a schematic plan view onto an upper surface of a common sample slide assembly comprising plural well elements, the well elements having an identical shape and orientation in said plan view, namely as known from the present invention's technical background.

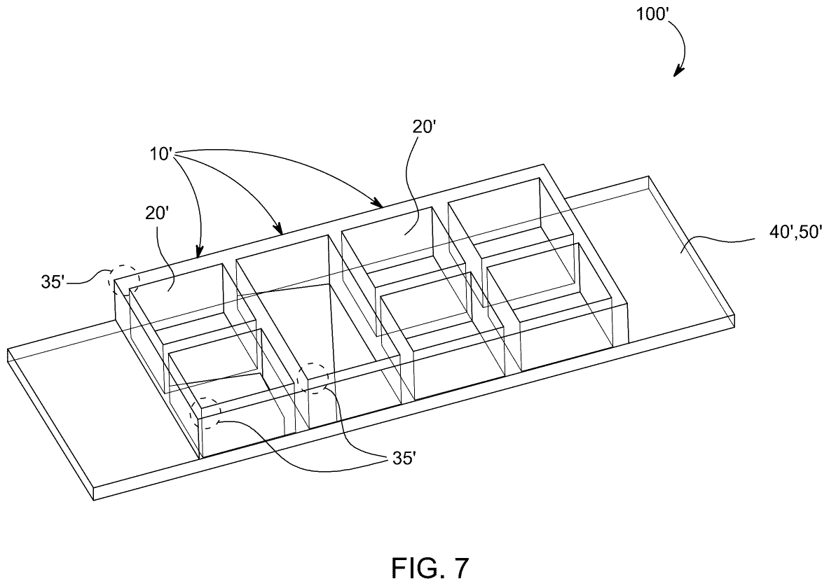

FIG. 7 is a schematic, perspective, and partially cross-sectional view of an alternative common sample slide assembly comprising plural well elements, the well elements partially having an identical shape and a comparable orientation in a plan view on an upper surface, namely as known from the present invention's technical background.

In the following, embodiments and the technical background of the present invention are presented in detail by taking reference to accompanying FIGS. 1 to 7. Identical or equivalent elements and elements which act identically or equivalently are denoted with the same reference signs. Not in each case of their occurrence a detailed description of the elements and components is repeated.

The depicted and described features and further properties of the invention's embodiments can arbitrarily be isolated and recombined without leaving the gist of the present invention.

In the following and first of all, a preliminary and very general view is taken on the enclosed figures, with a particular focus on FIGS. 1 to 7:

First of all in connection with FIGS. 6 and 7, the present invention's technical background is described.

Accordingly, FIG. 6 is a schematic plan view onto an upper surface of a common sample slide assembly 100′ comprising plural common well elements 10′, wherein the common well elements 10′have an identical shape and orientation in said plan view.

In addition, FIG. 7 is a schematic, perspective, and partially cross-sectional view of an alternative common sample slide assembly 100′, which comprises plural common well elements 10′either, wherein the common well elements 10′partially have an identical shape and a comparable orientation in a plan view on an upper surface of the common body 40′ or the common slide 50′.

As shown in the FIGS. 6 to 7 in general, according to the present invention's technical background a known sample slide assembly 100′ may comprise a common body 40′ which may be the body of a common sample slide 50′. On an upper surface of said common body 40′, a plurality of known well elements 10′ with a common configuration is formed, in the arrangements as shown in FIGS. 6 and 7.

As further shown in FIGS. 6 and 7, the side edges or lateral edges of the common well elements 10′ are oriented in parallel to the side edges or lateral edges of the superordinate common body 40′ or common slide 50′, wherein in general a tilting or tilt axis is also oriented parallely to the side edges or lateral edges of the common body 40′ or the common slide 50′.

Accordingly and when trying to aspirate the entire amount of fluid, the specimen and/or the sample contained in the volume or vessel of a common well 10′, either two tilting operations about the non-parallel tilting axes or a single tilt about a tilting axis having nontrivial angles, i.e. angles which are not 0° or 180°, with said side edges or lateral edges of the common body 40′ and the common slide 50′ are required.

Consequently, such a common design as shown in FIGS. 6 and 7 requires plural actuators or tilting mechanisms and/or a comparable complicated handling, i.e. tilting operation of a single actuator or tilting mechanism, namely in order to improve accumulation of any remaining fluid in the common well 10′ in the region of a common apex 35′ or corner 35′.

As already indicated in detail above, such a burden of equipment and/or of handling operation increases the risk of decreasing operation accuracy and/or of damage of at least one of the well structure and/or of any involved aspiration device.

The present invention attempts resolving the burden of complexity and of avoiding the problems assigned therewith. The present invention's attempts are shown in the sequence of FIGS. 1 to 5 as described in more detail in the following:

FIGS. 1 and 2 are schematic cross sectional side views of a first and a second embodiment, respectively, of the present invention's sample slide assembly 100, each comprising at least one well 10 or well element 10 each formed according to an embodiment of the present invention.

Therefore, a well element 10 for a sample slide assembly 100 and designed according to the present invention's gist comprises a depressed recess portion 20 and/or a concave recess portion 20 which is formed in or on an upper surface 41 of an underlying body 40.

In addition, a rim portion 30 is formed which spatially surrounds said recess portion 20 in a plan view and/or in a cross-sectional view onto said upper surface 41 of said body 40.

The rim portion 30 has an apex 35 or a cusp 35 which—in said plan view—is pointing towards at least one of a side or a side edge 43, 44, 45, 46 and/or an assigned tilting axis X, Y of the well 10 and/or of its body 40. The apex 35 may also be referred to as a tip, peak, point, corner. Furthermore, the apex 35 is defined by margining or bordering elements of the rim portion 30 which may form an angle 35a of the apex.

According to FIG. 1, the recess portion 20 may be formed purely as a depression in the upper surface 41 of the body 40.

Alternatively and according to FIG. 2, the recess portion 20 may be formed by building up walls of the rim portion 30 on the upper surface 41 of the body 40.

Of course, both concepts of FIGS. 1 and 2 may be combined.

As can be seen in more detail from the schematic and plan views of FIGS. 3 to 5, namely onto a respective upper surface 41 of an embodiment of the present invention's sample slide assembly 100, a body 40 or a slide 50 and with comprising plural well elements 10 with an identical shape of a certain kind in said plan view, the shape of the respective well element 10 may be defined in plan view by the shape of the underlying rim portion 30 (i) which may be or may form a polyline or a polygonal chain and/or (ii) which may be or may form a curved line or a concatenation of curved lines each defined by the rim's wall elements.

In FIG. 3, the rim portion 30 of the respective plural well elements 10 appears as a parallelogram or as a rhomb of identical shape, dimension, size, and orientation.

According to FIG. 4, the shape of a hexagon (forming a kind of arrow with the head and the tail of the arrow pointing into the same direction) is chosen for the plan view configuration of the rim portion 30 of the well elements 10.

In addition and according to FIG. 5, the shape of a section of an oval may alternatively be used for the shape of the rim portion 30 of the present invention's well element 10.

Irrespectively of the concrete nature of the shape of the rim portion 30 of the well element 10 in a plan view onto the upper surface 41 of the underlying body 40 or slide 50, in each case an apex 35 or cusp 35 is formed which directly points towards a lateral edge 43 or side edge 43 and also towards an assigned tilting axis X.

In order to form such an apex 35 or cusp 35, the rim portion 30 or a part thereof—in said plan view may be or may form a side, side edge or lateral edge of the well 10 that is not parallel to a side edge or lateral edge 43, 44, 45, 46 and/or an assigned tilting axis X of the well 10, its body 40, or the superordinate slide 50. This is realized in the embodiments as shown in FIGS. 3 and 4.

From the entire sequence of FIGS. 3 to 5, it can be obtained that the rim portion 30 or a part thereof—in said plan view—may be or may form two sides of the well element 10 which are joint in connection and in or at an angle 35a that is—in particular-different from 0° and from 180°, with the connection and the angle 35a forming the apex 35 as a point or as a region which is—among all other points of the joint two sides (i) in their entirety or (ii) in a neighborhood of said apex 35—located closest or nearest to a side edge 43, 44, 45, 46 and/or an assigned tilting axis X of the well 10, the slide 50 and/or their body 40.

In each case of the present invention's embodiments and as inter alia shown in FIGS. 1 to 5, the body 40 may be (i) a slide body or a body of a sample slide 50, each of a superordinate sample slide assembly 100, or a respective part thereof, (ii) a planar or essentially planar member, and (iii) a platelike or essentially platelike member.

In this regard, the body 40 may alternatively or additionally have a planar or an essentially planar upper surface 41 and a lower surface 42 which is opposed to the upper surface 41.

In the technical context of any application, the apex 35 or cusp 35 of the rim portion 30 and their geometric features may be configured in order to be suitable for being used as fiducial targets in order to determine and/or to register a location and/or an orientation of the well element 10, of the body 40, of the slide 50, and/or of the superordinate sample slide assembly 100 in its entirety.

These and further aspects of the present invention will also be described in detail in the following passages:
The present invention inter alia proposes a design for a well 10 or well element 10 which is suitable—but not only—for robust reagent exchange systems and/or optical alignment systems and/or which may inter alia be formed and used as consumable entities.

Current sample slide assemblies or SSAs 100′, as inter alia used for tissue placement and reagent exchange, employ conventional wells 10′ of square or rectangular shape in or on an underlying conventional substrate 40′ or body 40′.

In order to aspirate reagent out from such a known well 10′, the whole underlying known SSA 100′ is tilted about both a superordinate tilting axes X and Y or about an axis that forms a non-trivial angle which is different from 0° and 90° with both the superordinate spatial axes x and y in a manner so that the reagent can accumulate to one corner 35′ of the well 10′.

Under such a tilted configuration, e.g. a pipette tip or any other means for removing fluid can be positioned close to the apex 35′ or the corner 35′ in order to aspirate out any remaining reagent.

The closer the pipette tip or other means is placed to the apex 35′, the less residual reagent remains in the well 10′ after aspiration.

However, tilting the common SSA 100′ in both about the X and the Y axis or about an axis in an angle that is not orthogonal or parallel to the mechanical or spatial axes x and y of a typical liquid handling device increases the complexity of the overall arrangement and of the handling thereof, namely as two tilt motors with precision control on angle and their particular control are required. Also, reliability concerns may come up, namely as any position inaccuracy could result in pipette tip crashing into the bottom of the common SSA 100′, causing leakage of the common reagent wells 10′.

As shown in FIGS. 6 and 7, the former yielding a top view on a known and common sample slide assembly 100′ with two wells 10′, this known assembly 100′ needs to be tilted about both the X axis and the Y in order to accumulate reagent inside the well 10′ into a region of a single corner 35′ of a well 10′ thereof. Alternatively, a tilt about an axis that forms a non-trivial angle with both X and the Y axis, e.g. diagonal with respect to the slide as shown in FIG. 7 may be performed.

The present invention inter alia aims at simplifying the tilt station and the tilt operation and at improving their reliability. As a consequence, various design concepts can be used in order to reduce the tilt station or tilt operation to a single-axis tilt-concept, in particular about either the superordinate X axis or the superordinate Y axis.

In addition, some embodiments of designs for wells 10 may also convey fiducial features for alignment by vision systems.

According to one embodiment of the present invention, one side of a reagent well 10 may by designed in order to be not fully parallel to a superordinate rotational axis X of a tilt station for reagent accumulation towards a lower corner 35 of the well 10 in a tilted state.

According to an alternative or additional embodiment of the present invention, two sides of the well 10 may have or may form a joint in an angle 35a and the apex 35 of said angle 35a can be at the lowest point or region of a bottom of the well 10 in the tilted state.

Further alternatively or additionally, the well 10 may have a curved side with an apex 35 as a lowest point in height when the bottom of the well 10 is tilted.

Further additionally or alternatively, features of the apex 35 or corner 25 may serve as and may be used as fiducial targets in order to determine and to register a location and/or orientation of the superordinate SSA 100.

### LIST OF REFERENCE SIGNS

10 well, reagent well, well element, well configuration
10′ conventional well
20 recess, recess portion
20′ conventional recess
30 rim, rim portion
30′ conventional rim
35 apex, cusp, tip, peak, point, corner
35′ conventional apex
35a angle of apex 35 or corner 35
40 body, slide body, substrate
40′ conventional body
41 upper surface, front surface
42 lower surface, back surface
43 edge, side edge
44 edge, side edge
45 edge, side edge
46 edge, side edge
50 sample slide
50 conventional sample slide
60 reagent/fluid residue
100 sample slide assembly
100′ conventional sample slide assembly
X spatial direction
X direction of the longitudinal extension, rotational axis
y spatial direction
y direction of the transversal extension, rotational axis
Z spatial direction
Z spatial direction of height extension

1. A well element for a sample slide assembly,
comprising:
a depressed and/or concave recess portion which is formed in or on an upper surface of a body, and
a rim portion surrounding said recess portion in a plan view and/or in a cross-sectional view onto said upper surface of said body,
wherein said rim portion has an apex or a cusp which—in said plan view—is pointing towards at least one of:
a side or a side edge and
an assigned tilting axis (X, Y)
of the well and/or its body.

2. The well element according to claim 1, wherein the rim portion or a part thereof—in said plan view—has the shape of a polyline or of a polygonal chain.

3. The well element according to claim 1, wherein the rim portion or a part thereof—in said plan view—has the shape of a curved line or of a concatenation of curved lines.

4. The well element according to claim 1, wherein the rim portion or a part thereof—in said plan view—is or forms a side of the well element that is not parallel to
a side edge and/or
an assigned tilting axis (X, Y)
of the well and/or its body.

5. The well element according to claim 1, wherein the rim portion or a part thereof—in said plan view—is or forms two sides of the well element which are joint in connection and in or at an angle that is—in particular—different from 0° and from 180°, with the connection and the angle forming the apex as a point or as a region which is—among all other points of the joint two sides (i) in their entirety or (ii) in a neighborhood of said apex—located closest or nearest to
a side edge and/or
an assigned tilting axis (X, Y)
of the well and/or its body.

6. The well element according to claim 1, wherein the body at least one of:
is a slide body or a body of a sample slide, each of a superordinate sample slide assembly, or a respective part thereof,
is a planar or essentially planar member,
is a platelike or essentially platelike member, and
has a planar or an essentially planar upper surface and a lower surface which is opposed to the upper surface.

7. The well element according to claim 1, wherein the apex or cusp of the rim portion and their geometric features are configured in order to be suitable for being used as fiducial targets in order to determine and/or to register a location and/or an orientation of the well element of the body, and/or of a superordinate sample slide assembly.

8. A sample slide assembly,
comprising a slide body having an upper surface,
wherein:
in or on said upper surface at least one well element comprising:
a depressed and/or concave recess portion which is formed in or on an upper surface of the body, and
a rim portion surrounding said recess portion in a plan view and/or in a cross-sectional view onto said upper surface of said body,
wherein said rim portion has an apex or a cusp which in said plan view is pointing towards at least one of:
a side or a side edge, and
an assigned tilting axis (X, Y)
of the well and/or its body,
in a plan view onto said upper surface of said slide body, said upper surface is surrounded by side edges, and
the well element is oriented in or on the surface such that the apex or cusp of the well element is pointing towards one of said side edges and/or a tilting axis assigned to said slide assembly.

9. The sample slide assembly according to claim 8, wherein the slide body at least one of:
is planar or essentially planar,
is platelike or essentially platelike,
has planar or essentially planar upper surface, and
has a lower surface opposed to said upper surface.

10. The sample slide assembly according to claim 8,
comprising plural well elements,
wherein said plural well elements are—in particular—identical in form, shape, dimension, and/or orientation.

11. A treatment apparatus, for treating a sample slide assembly,
comprising:
a holding means for releasably holding the sample slide assembly, and
a tilting means for conditionally and/or controllably tilting a sample slide assembly, which is held by said holding means, about a tilting axis (X),
wherein said holding means and/or said tilting means are configured such that, when holding the sample slide assembly comprising:
a slide body having an upper surface,
wherein:
in or on said upper surface at least one well element comprising:
a depressed and/or concave recess portion which is formed in or on an upper surface of a body, and
a rim portion surrounding said recess portion in a plan view and/or in a cross-sectional view onto said upper surface of said body,
wherein said rim portion has an apex or a cusp which in said plan view is pointing towards at least one of:
a side or a side edge, and
an assigned tilting axis (X, Y)
of the well and/or its body,
in a plan view onto said upper surface of said slide body, said upper surface is surrounded by side edges, and
the well element is oriented in or on the surface such that the apex or cusp of the well element is pointing towards one of said side edges and/or a tilting axis assigned to said slide assembly,
the apex or the cusp of a rim portion the well element of the sample slide assembly—in said plan view onto the slide body is pointing towards the tilting axis (X).

12. (canceled)
